(19) United States
(12) Patent Application Publication
(10) Pub. No.: US 2022/0282037 A1
(43) Pub. Date: Sep. 8, 2022

(54) High-barrier biodegradable Doypack and preparation method therefor

(71) Applicant: JIANGSU GOLDEN RAINBOW NEW MATERIAL CO., LTD., Danyang (CN)

(72) Inventors: Peng SI, Danyang (CN); Zhigang LIU, Danyang (CN); Weiguo WU, Danyang (CN); Peng LIANG, Danyang (CN); Guofang LI, Danyang (CN)

(21) Appl. No.: 17/752,855

(22) Filed: May 25, 2022

Related U.S. Application Data
(63) Continuation of application No. PCT/CN2020/098646, filed on Jun. 29, 2020.

(30) Foreign Application Priority Data
Nov. 26, 2019 (CN) 201911171015.3

(51) Int. Cl. C08G 64/02; B65D 75/00; B65D 33/25; B29C 48/21; B29C 48/00; B29C 48/08

(52) U.S. Cl. CPC C08G 64/0208; B65D 75/008; B65D 33/2508; B29C 48/21; B29C 48/022; B29C 48/08; B29K 2069/00

(57) ABSTRACT

A high-barrier biodegradable Doypack and a preparation method therefor. The Doypack consists of two parts, a high-barrier biodegradable self-sealing strip and a five-layered composite high-barrier biodegradable Doypack body. The main base materials of the high-barrier biodegradable self-sealing strip are PLGA and PPC that have excellent barrier performance; and the five-layered composite high-barrier biodegradable Doypack body consists of single side glossy white Kraft paper, a bonding layer, a first barrier layer, a second barrier layer, and a heat-sealing layer, which are integrally formed by using a process combining four-layer co-extrusion and lamination. Compared to conventional non-degradable Doypacks, the high-barrier biodegradable Doypack is substantially equivalent in terms of the physical and mechanical performance and heat-sealing performance, but has a superior barrier performance, and is biodegradable.

### CROSS REFERENCE TO RELATED PATENT APPLICATION

The present application is the U.S. continuation of PCT/CN2020/098646 filed on Jun. 29, 2020, which claims the priority of the Chinese patent application No. 201911171015.3 filed on Nov. 26, 2019, which is incorporated herein by reference.

### FIELD OF THE INVENTION

The disclosure belongs to the field of food packaging. It relates to a sealed Doypack, and more specifically, to a high-barrier biodegradable Doypack and a preparation method thereof.

### TECHNICAL BACKGROUND

The Doypack was first invented in 1963. It was promoted from the United States in the 1990s, and gradually recognized globally. Now it has penetrated into many corners of our lives. At present, the Doypack are mainly divided into five basic types: ordinary Doypack, Doypack with nozzles, seal type Doypack, mouth-proof Doypack and special-shaped Doypack. Among them, seal type Doypack are widely used in our lives, such as nuts, candies, biscuits, jellies and other food packaging fields.

The seal type Doypack consists of two main parts, the self-sealing strip and the multilayer composite high-barrier bag body. The main material of the self-sealing strip is PE or PP, which is made by extrusion molding. Multilayer composite high-barrier bag body generally include printing layer, bonding layer, barrier layer, heat-sealing layer. The most important of which is the barrier layer. At present, the materials of the barrier layer used in large quantities mainly include PET, nylon, EVOH, aluminum foil, and Aluminum plating film, etc. The use of seal type Doypack has brought great convenience to our lives, but a large number of discarded seal type Doypacks have also caused serious “white pollution” to our environment. Because the bag body is multi-layer composite structure, the recycling of materials of the bag body faces huge technical obstacles and high recycling costs. Popularizing the use of biodegradable Doypack is considered to be the most fundamental and effective way to solve this problem.

So the development of high-barrier biodegradable self-seal strips and multilayer composite high-barrier biodegradable bag has become the key to the preparation of seal type biodegradable Doypack.

The application CN109627703A discloses a method for preparing biodegradable self-sealing strips. Only two materials of PLA and PBAT are used. Biodegradable self-sealing strips with good sealing performance can be prepared after simple blending and extrusion. After being compounded with laminated non-woven fabric, a zipper bag is prepared. However, since the main materials of the seals are PLA and PBAT, and the oxygen and water vapor transmission rates of these two materials are very large, the biodegradable seal prepared by this method cannot be used for packing Doypack with high barrier properties.

Many scientific researchers have done meticulous work on the development of high-barrier biodegradable films, and achieved good results. e.g:

Zhang Xinlin of Beijing Institute of Graphic Communication and others used plasma enhanced chemical vapor deposition to prepare SiOx barrier layer on the surface of PLA material. The barrier layer greatly improves the barrier properties of PLA. However, this method has a relatively high cost for preparing films, and it is unfavourable for industrial application.

The NatureWorks company of the US prepared PLA aluminized film with excellent comprehensive performance. A high-barrier biodegradable film is prepared by the PLA aluminized film compounding with paper, and it is successfully prepared into a packaging bag. However, after the composite material is degraded, aluminum will still remain in nature and is difficult to recycle, which may affect the quality of crops and endanger the health of humans and animals.

Kureha Corporation of Japan discloses a biodegradable high-barrier film in the application CN101945749A. The method first prepares a PGA film with excellent barrier properties through a biaxial stretching process, and then adopts a lamination method to combined with paper, polylactic acid, polysuccinic acid and polycaprolactone, it can be prepared into a biodegradable multilayer composite high barrier film. The barrier performance of the multilayer composite biodegradable film prepared by this method is indeed excellent, but the investment in biaxial stretching equipment is very huge, the multi-step lamination preparation process is complicated, the production cost is high. Moreover, in the multi-step lamination process, oxygen and water vapor are easy to remain between the PGA biaxial tensile film and other material layers, which is easy to cause performance degradation for PGA with rapid degradation speed.

Among all biodegradable plastics, polyglycolic acid (PGA) has the best barrier properties, so it will be the preferred material for Doypacks that require higher barrier properties. However, PGA itself has disadvantages such as too fast degradation rate and too high melting point (there is no processing temperature overlap zone with other biodegradable plastics), which makes it very difficult to use PGA and other biodegradable plastics in the process of blending modification and co-extrusion.

### SUMMARY OF THE PRESENT DISCLOSURE

Technical problem to be solved: In view of the current situation of serious “white pollution”, difficulty in recycling and high cost after a large number of non-degradable seal type Doypacks are discarded, the present disclosure provides a high-barrier biodegradable Doypack and a preparation method thereof. The design principles are as follows:
1. Based on the multicomponent composite modification technology, PLGA, a rigid material with low melting point and excellent barrier properties, and PPC, a flexible material with excellent barrier properties, are preferred as the main base material, and PBS with excellent resilience is preferred as the auxiliary material. And the reaction is added reactive compatibilizer poly (N-Propionyl aziridine), blocked modifier o-Phthalic anhydride (to inhibit the thermal oxygen degradation of PLGA and PPC during processing) and compound slip agent, through melting the high barrier biodegradable seal modified material is prepared by blending;
2. Blend organic modified montmorillonite and PBAT to improve the barrier properties of PBAT, and blend the hyperbranched polyester HyPer C181 to improve the fluidity of the melt, and make it match with the melt flow rate of other layers during coextrusion.
3. Preferably, tributyl O-acetylcitrate is used to plasticize and modify PGA to lower its melting point temperature, so that it has a processing temperature overlap area when co-extrusion with other layers of biodegradable materials. Polyvinyl acetate is added to increase the adhesion with other layers.
4. Use maleic anhydride to block modified PPC to inhibit its “unzipper” degradation during processing, and add hyperbranched polyester HyPer C100 to improve the fluidity of the melt, so that it can match with the melt flow rate of other layers during coextrusion.
5. Combine the four-layer coextrusion and film coating process to prepare a five-layer composite high-barrier biodegradable film through a one-time molding process. Technical solutions to be protected by the present disclosure:

### Technical Solution One

A method for preparing a high-barrier biodegradable Doypack includes the following steps:

### Process 1. Prepare High-Barrier Biodegradable Self-Sealing Strip

(1.1) Prepare the raw material(weight fractions): 5-10 parts of poly (lactide-co-glycolide) (PLGA), 60-70 parts of polypropylene carbonate (PPC), and 20-30 parts of Polybutylene succinate (PBS), 1 part of Poly (N-Propionylaziridine), 0.5 parts of o-Phthalic anhydride, 0.2 parts of erucylamide, 0.5 parts of nano-silicon dioxide, 0.3 parts of white mineral oil.

(1.2) Mix uniformly the PLGA, PPC, PBS, Poly (N-Propionylaziridine), o-Phthalic anhydride, erucylamide, nano-silicon dioxide, white mineral oil prepared in step (1.1) and add them to the parallel twin screw extruder (commercially equipment, prior art), melt blending and air-cooled pelletizing to prepare high-barrier biodegradable self-sealing strip modified material.

(1.3) The high-barrier biodegradable self-sealing strip modified material prepared in step (1.2) is added to the bone strip extruder (commercially available, prior art), melted, extruded, water-cooled and shaped, and made into a high-barrier Biodegradable self-sealing strips;

### Process 2: Prepare Five-Layer Composite High-Barrier Biodegradable Film Roll

(2.1) PBAT, organic modified montmorillonite, hyperbranched polyester HyPer C181, and white oil are mixed uniformly and then added to the parallel twin screw extruder, melted, blended and air-cooled pelletizing to prepare the bonding layer modification material.

(2.2) PGA, tributyl O-acetylcitrate, Polyvinyl acetate, and antioxidant 168 are mixed uniformly and then added to the parallel twin screw extruder, melted, blended and air-cooled pelletizing to prepare a first barrier layer modified material.

(2.3) PPC, maleic anhydride, antioxidant 1010, hyperbranched polyester HyPer C100, and white mineral oil are mixed uniformly and then added to the parallel twin screw extruder, melted, blended and air-cooled pelletizing to prepare a second barrier layer modified material.

(2.4) Add the modified materials prepared in steps (2.1), (2.2), (2.3) and PBS separately to the four extruders of a four-layer coextrusion casting machine (commercially equipment, prior art). Starts the four extruders in sequence. By adjusting the rotating speed of each extruder, four-layer coextruded cast film with different thickness for each layer can be prepared. The four-layer coextruded cast film is composed of a heat sealing layer, a second barrier layer, a first barrier layer and a bonding layer from top to bottom. After the melt flow is stable, it is coated on the single side glossy white kraft paper and the rough surface of the single side glossy white kraft paper is in contact with the bonding layer of the melt. After trimming, it is made into a five-layer composite high-barrier biodegradable film roll. It is used to prepare the body of high-barrier biodegradable bag. From the outside to the inside, the five-layer composite high-barrier biodegradable film are: a printing layer, a bonding layer, a first barrier layer, a second barrier layer, and a heat-sealing layer.

(3) The high-barrier biodegradable self-seal strip prepared in step (1.3) and the five-layer composite high-barrier biodegradable film roll prepared in step (2.4) are prepared into a high-barrier biodegradable Doypack by a bone-sticking three-side sealing bag making machine.

Further, in the PLGA described in step (1.1), the repeating unit —OCH₂CO-accounts for 80%˜90%, the weight average molecular weight (Mw) of PLGA is 100,000˜200,000.

Further, step (2.1) prepares the bonding layer modified material with the raw material formula(weight fraction): 92 parts of Poly (butyleneadipate-co-terephthalate) (PBAT), 7 parts of organic modified montmorillonite, 1 part of hyperbranched polyester HyPer C181, 0.3 part of white mineral oil.

Further, the first barrier modified material prepared in step (2.2) with the raw material formula(weight fraction): 90 parts of polyglycolide (PGA), 5 parts of tributyl O-acetylcitrate, 5 parts of Polyvinyl acetate, and 0.5 parts of antioxidant 168.

Further, the weight average molecular weight (Mw) of PGA described in step (2.2) is 150,000˜300,000, and the residual amount of Glycolide is not more than 0.3 wt %.

Further, the second barrier layer modified material prepared in step (2.3) with the raw material formula(weight fraction): 100 parts of polypropylene carbonate(PPC), 0.5 parts of maleic anhydride, 0.3 parts of antioxidant 1010, and 0.5 parts of hyperbranched polyester HyPer C100, 0.3 parts of white mineral oil.

Further, in the cast film extruded by the extruder in step (2.4), the thickness of the bonding layer is 5-10 microns.

Further, in the coextruded cast film specified in step (2.4), the thickness of the first barrier layer is 20-40 microns.

Further, in the coextruded cast film specified in step (2.4), the thickness of the second barrier layer is 20-40 microns.

Further, in the coextruded cast film specified in step (2.4), the thickness of the heat-sealing layer is 5-10 microns, and the material of the heat-sealing layer is Polybutylene succinate (PBS).

Further, the single side glossy white kraft paper described in step (2.4) is the printing layer with a density of 50g/m² and the thickness is 65 microns.

### Technical Solution Two

A high-barrier biodegradable Doypack prepared by the above preparation method is composed of a high-barrier biodegradable self-seal strip and a five-layer composite high-barrier biodegradable bag body.

### Benefits:

Compared with the existing sealed Doypack, the biodegradable Doypack made of the present disclosure has a biodegradation rate of more than 90% in 180 days under the industrial composting state, lower oxygen transmission rate and water vapor transmission rate, does not contain the aluminum-plated composition, has simple preparation process and low production cost. It is of great significance to solve the problem of “white pollution” caused by abandoned Doypacks.

### DETAILED DESCRIPTION OF THE PREFERRED EMBODIMENT

The following embodiment further illustrate the content of the present disclosure. In the embodiment, the size of the Doypack is designed to be 9×(14+3) cm, which is consistent with the product size of the comparative example.

### Embodiment 1

(1) Mix 5 parts of PLGA (repeat unit —OCH₂CO— accounts for 80%, Mw 100000), 70 parts of PPC, 25 parts of PBS, 1 part of Poly (N-Propionyl aziridine), 0.5 part of o-Phthalic anhydride, 0.2 part of Erucylamide, 0.5 part of nano-silicon dioxide, 0.3 part of white mineral oil uniformly and add them to the parallel twin screw extruder, melt blending and air-cooled pelletizing to prepare high-barrier biodegradable self-sealing strip modified material.

(2) The high-barrier biodegradable self-sealing strip modified material prepared in step (1) is added to the bone strip extruder melted, extruded, water-cooled and shaped, and made into a high-barrier Biodegradable self-sealing strips.

(3) 92 parts of PBAT, 7 parts of organic modified montmorillonite, 1 part of hyperbranched polyester HyPer C181, and 0.3 parts of white oil are mixed uniformly and then added to the parallel twin screw extruder, melted, blended and air-cooled pelletizing to prepare the bonding layer modification material.

(4) 90 parts of PGA (Mw is 150000, the residual amount of Glycolide is 0.15 wt %), 5 parts of tributyl O-acetylcitrate, 5 parts of Polyvinyl acetate, and 0.5 part of antioxidant 168 are mixed uniformly and then added to the parallel twin screw extruder, melted, blended and air-cooled pelletizing to prepare the first barrier layer modified material.

(5) 100 parts of PPC, 0.5 parts of maleic anhydride, 0.3 parts of antioxidant 1010, 0.5 parts of hyperbranched polyester HyPerC100, and 0.3 parts of white mineral oil are mixed uniformly and then added to the parallel twin screw extruder, melted, blended and air-cooled pelletizing to prepare the second barrier layer modified material.

(6) Add the modified materials prepared in steps (3),(4),(5) and PBS separately to the four extruders of a four-layer coextrusion casting machine, and start the four extruders in sequence. By adjusting the rotating speed of each extruder, four-layer coextruded cast film with different thickness for each layer can be prepared: thickness of the bonding layer is 5 microns, thickness of the first barrier layer is 20 microns, thickness of the second barrier layer is 40 microns, thickness of the heat-sealing layer is 10 microns. From top to bottom, the four-layer coextruded cast film is the heat-sealing layer, the second barrier layer, the first barrier layer, and the bonding layer. After the melt flow is stable, it is coated on the single side glossy white kraft paper and the rough surface of the single side glossy white kraft paper is in contact with the bonding layer of the melt. After trimming, it is made into a five-layer composite high-barrier biodegradable film roll which the thickness is 140 microns.

(7) The high-barrier biodegradable self-seal strip prepared in step (2) and the five-layer composite high-barrier biodegradable film roll prepared in step (6) are prepared into a high-barrier biodegradable Doypack by a bone-sticking three-side sealing bag making machine. The size of the Doypack is 9×(14+3)cm.

### Embodiment 2

(1) Mix 10 parts of PLGA (repeat unit —OCH₂CO— accounts for 90%, Mw is 200,000), 60 parts of PPC, 30 parts of PBS, 1 part of Poly (N-Propionyl aziridine), 0.5 parts of o-Phthalic anhydride, 0.2 part of Erucylamide, 0.5 part of nano-silicon dioxide, 0.3 part of white mineral oil uniformly and add them to the parallel twin screw extruder, melt blending and air-cooled pelletizing to prepare high-barrier biodegradable self-sealing strip modified material.

(2) The high-barrier biodegradable self-sealing strip modified material prepared in step (1) is added to the bone strip extruder melted, extruded, water-cooled and shaped, and made into a high-barrier Biodegradable self-sealing strips.

(3) 92 parts of PBAT, 7 parts of organic modified montmorillonite, 1 part of hyperbranched polyester HyPer C181, and 0.3 parts of white oil are mixed uniformly and then added to the parallel twin screw extruder, melted, blended and air-cooled pelletizing to prepare the bonding layer modification material.

(4) 90 parts of PGA (Mw is 300,000, the residual amount of Glycolide is 0.1 wt %), 5 parts of tributyl O-acetylcitrate, 5 parts of Polyvinyl acetate, and 0.5 part of antioxidant 168 are mixed uniformly and then added to the parallel twin screw extruder, melted, blended and air-cooled pelletizing to prepare the first barrier layer modified material.

(5) 100 parts of PPC, 0.5 parts of maleic anhydride, 0.3 parts of antioxidant 1010, 0.5 parts of hyperbranched polyester HyPerC100, and 0.3 parts of white mineral oil are mixed uniformly and then added to the parallel twin screw extruder, melted, blended and air-cooled pelletizing to prepare the second barrier layer modified material.

(6) Add the modified materials prepared in steps (3),(4),(5) and PBS separately to the four extruders of a four-layer coextrusion casting machine, and start the four extruders in sequence. By adjusting the rotating speed of each extruder, four-layer coextruded cast film with different thickness for each layer can be prepared: thickness of the bonding layer is 5 microns, thickness of the first barrier layer is 20 microns, thickness of the second barrier layer is 40 microns, thickness of the heat-sealing layer is 10 microns. From top to bottom, the four-layer coextruded cast film is the heat-sealing layer, the second barrier layer, the first barrier layer, and the bonding layer. After the melt flow is stable, it is coated on the single side glossy white kraft paper and the rough surface of the single side glossy white kraft paper is in contact with the bonding layer of the melt. After trimming, it is made into a five-layer composite high-barrier biodegradable film roll which the thickness is 140 microns.

(7) The high-barrier biodegradable self-seal strip prepared in step (2) and the five-layer composite high-barrier biodegradable film roll prepared in step (6) are prepared into a high-barrier biodegradable Doypack by a bone-sticking three-side sealing bag making machine. The size of the Doypack is 9×(14+3)cm.

### Embodiment 3

(1) Mix 10 parts of PLGA (repeat unit —OCH₂CO— accounts for 90%, Mw is 200,000), 70 parts of PPC, 20 parts of PBS, 1 part of Poly (N-Propionyl aziridine), 0.5 parts of o-Phthalic anhydride, 0.2 part of Erucylamide, 0.5 part of nano-silicon dioxide, 0.3 part of white mineral oil uniformly and add them to the parallel twin screw extruder, melt blending and air-cooled pelletizing to prepare high-barrier biodegradable self-sealing strip modified material.

(2) The high-barrier biodegradable self-sealing strip modified material prepared in step (1) is added to the bone strip extruder melted, extruded, water-cooled and shaped, and made into a high-barrier Biodegradable self-sealing strips.

(3) 92 parts of PBAT, 7 parts of organic modified montmorillonite, 1 part of hyperbranched polyester HyPer C181, and 0.3 parts of white oil are mixed uniformly and then added to the parallel twin screw extruder, melted, blended and air-cooled pelletizing to prepare the bonding layer modification material.

(4) 90 parts of PGA (Mw is 300,000, the residual amount of Glycolide is 0.1 wt %), 5 parts of tributyl O-acetylcitrate, 5 parts of Polyvinyl acetate, and 0.5 part of antioxidant 168 are mixed uniformly and then added to the parallel twin screw extruder, melted, blended and air-cooled pelletizing to prepare the first barrier layer modified material.

(5) 100 parts of PPC, 0.5 parts of maleic anhydride, 0.3 parts of antioxidant 1010, 0.5 parts of hyperbranched polyester HyPerC100, and 0.3 parts of white mineral oil are mixed uniformly and then added to the parallel twin screw extruder, melted, blended and air-cooled pelletizing to prepare the second barrier layer modified material.

(6) Add the modified materials prepared in steps (3),(4),(5) and PBS separately to the four extruders of a four-layer coextrusion casting machine, and start the four extruders in sequence. By adjusting the rotating speed of each extruder, four-layer coextruded cast film with different thickness for each layer can be prepared: thickness of the bonding layer is 10 microns, thickness of the first barrier layer is 30 microns, thickness of the second barrier layer is 30 microns, thickness of the heat-sealing layer is 5 microns. From top to bottom, the four-layer coextruded cast film is the heat-sealing layer, the second barrier layer, the first barrier layer, and the bonding layer. After the melt flow is stable, it is coated on the single side glossy white kraft paper so that the rough surface of the single side glossy white kraft paper is in contact with the bonding layer of the melt. After trimming, it is made into a five-layer composite high-barrier biodegradable film roll which the thickness is 140 microns.

(7) The high-barrier biodegradable self-seal strip prepared in step (2) and the five-layer composite high-barrier biodegradable film roll prepared in step (6) are prepared into a high-barrier biodegradable Doypack by a bone-sticking three-side sealing bag making machine. The size of the Doypack is 9×(14+3)cm.

### Embodiment 4

(1) Mix 10 parts of PLGA (repeat unit —OCH₂CO— accounts for 90%, Mw is 200,000), 70 parts of PPC, 20 parts of PBS, 1 part of Poly (N-Propionyl aziridine), 0.5 parts of o-Phthalic anhydride, 0.2 part of Erucylamide, 0.5 part of nano-silicon dioxide, 0.3 part of white mineral oil uniformly and add them to the parallel twin screw extruder, melt blending and air-cooled pelletizing to prepare high-barrier biodegradable self-sealing strip modified material.

(2) The high-barrier biodegradable self-sealing strip modified material prepared in step (1) is added to the bone strip extruder melted, extruded, water-cooled and shaped, and made into a high-barrier Biodegradable self-sealing strips.

(3) 92 parts of PBAT, 7 parts of organic modified montmorillonite, 1 part of hyperbranched polyester HyPer C181, and 0.3 parts of white oil are mixed uniformly and then added to the parallel twin screw extruder, melted, blended and air-cooled pelletizing to prepare the bonding layer modification material.

(4) 90 parts of PGA (Mw is 300,000, the residual amount of Glycolide is 0.1 wt %), 5 parts of tributyl O-acetylcitrate, 5 parts of Polyvinyl acetate, and 0.5 part of antioxidant 168 are mixed uniformly and then added to the parallel twin screw extruder, melted, blended and air-cooled pelletizing to prepare the first barrier layer modified material.

(5) 100 parts of PPC, 0.5 parts of maleic anhydride, 0.3 parts of antioxidant 1010, 0.5 parts of hyperbranched polyester HyPerC100, and 0.3 parts of white mineral oil are mixed uniformly and then added to the parallel twin screw extruder, melted, blended and air-cooled pelletizing to prepare the second barrier layer modified material.

(6) Add the modified materials prepared in steps (3),(4),(5) and PBS separately to the four extruders of a four-layer coextrusion casting machine, and start the four extruders in sequence. By adjusting the rotating speed of each extruder, four-layer coextruded cast film with different thickness for each layer can be prepared: thickness of the bonding layer is 10 microns, thickness of the first barrier layer is 40 microns, thickness of the second barrier layer is 20 microns, thickness of the heat-sealing layer is 5 microns. From top to bottom, the four-layer coextruded cast film is the heat-sealing layer, the second barrier layer, the first barrier layer, and the bonding layer. After the melt flow is stable, it is coated on the single side glossy white kraft paper and the rough surface of the single side glossy white kraft paper is in contact with the bonding layer of the melt. After trimming, it is made into a five-layer composite high-barrier biodegradable film roll which the thickness is 140 microns.

(7) The high-barrier biodegradable self-seal strip prepared in step (2) and the five-layer composite high-barrier biodegradable film roll prepared in step (6) are prepared into a high-barrier biodegradable Doypack by a bone-sticking three-side sealing bag making machine. The size of the Doypack is 9×(14+3)cm.

### Comparative Experiment 1

In this embodiment, the first barrier layer and the second barrier layer are omitted from the five-layer composite high-barrier biodegradable film roll prepared, and are used for performance comparison with the five-layer composite Doypack prepared by the present disclosure.

(1) Mix 10 parts of PLGA (repeat unit —OCH₂CO— accounts for 90%, Mw is 200,000), 70 parts of PPC, 20 parts of PBS, 1 part of Poly (N-Propionyl aziridine), 0.5 parts of o-Phthalic anhydride, 0.2 part of Erucylamide, 0.5 part of nano-silicon dioxide, 0.3 part of white mineral oil uniformly and add them to the parallel twin screw extruder, melt blending and air-cooled pelletizing to prepare high-barrier biodegradable self-sealing strip modified material.

(2) The high-barrier biodegradable self-sealing strip modified material prepared in step (1) is added to the bone strip extruder melted, extruded, water-cooled and shaped, and made into a high-barrier Biodegradable self-sealing strips.

(3) 92 parts of PBAT, 7 parts of organic modified montmorillonite, 1 part of hyperbranched polyester HyPer C181, and 0.3 parts of white oil are mixed uniformly and then added to the parallel twin screw extruder, melted, blended and air-cooled pelletizing to prepare the bonding layer modification material.

(4) Add the modified materials prepared in steps (3) and PBS separately to the two extruders of a two-layer coextrusion casting machine, and start the two extruders in sequence. By adjusting the rotating speed of each extruder, two-layer coextruded cast film with different thickness for each layer can be prepared: thickness of the bonding layer is 35 microns, thickness of the PBS layer is 40 microns. From top to bottom, the two-layer coextruded cast film is the heat-sealing layer and the bonding layer. After the melt flow is stable, it is coated on the single side glossy white kraft paper and the rough surface of the single side glossy white kraft paper is in contact with the bonding layer of the melt. After trimming, it is made into a three-layer composite high-barrier biodegradable film roll which the thickness is 140 microns.

(5) The high-barrier biodegradable self-seal strip prepared in step (2) and the three-layer composite high-barrier biodegradable film roll prepared in step (4) are prepared into a high-barrier biodegradable Doypack by a bone-sticking three-side sealing bag making machine. The size of the Doypack is 9×(14+3)cm.

### Comparative Experiment 2

At present, the bag body of the seal type Doypack that are mass-produced and used on the market, according to the product description, is made of kraft paper+PET+CPP three-layer composite material. It is a non-degradable material. For comparison experiments, traditional seal type Doypack was purchased. The specific product model is: the bag body is made of kraft paper+PET+CPP three-layer composite material, the thickness of the single layer of the bag body is 140 microns, and the size of the Doypack is 9×(14+3)cm.

### Embodiment 5

This embodiment is to evaluate the physical and mechanical properties (including tensile break stress and heat seal strength) of the body material of the Doypack prepared in embodiment 1 to 4 and Comparative Experiment 2. The physical and mechanical properties are tested on a universal tensile testing machine (CMT-4304, made by Nss(Shenzhen) Laboratory Equipment Co., LTD). The tensile break stress is tested in accordance with GB/T1040.3-2006, the test speed is 250 mm/min, and the heat seal strength is in accordance with QB/T2358-1998, the test speed is 300 mm/min, and the test results are shown in Table 1.

TABLE 1
Physical and mechanical properties
of different Doypack body materials

| | Tensile Break Stress/N | | Heat seal strength |
|---|---|---|---|
| Doypack type | Lateral | Vertical | (N/15 mm) |
| Embodiment 1 | 48.57 | 46.79 | 32.74 |
| Embodiment 2 | 49.34 | 50.21 | 33.57 |
| Embodiment 3 | 56.49 | 55.37 | 27.37 |
| Embodiment 4 | 54.31 | 54.22 | 28.45 |
| Comparative | 51.66 | 50.84 | 30.31 |
| experiment 2 | | | |

From the embodiments in Table 1 and the comparative experiment, it can be concluded that the high barrier biodegradable Doypack material provided by the present disclosure has the same physical and mechanical properties as the traditional commercial Doypack. When the thickness of the first barrier layer reaches 30 microns, it has better tensile break stress performance than traditional commercial Doypack material. The heat seal strength of the high-barrier biodegradable Doypack material of the present disclosure is basically equivalent to that of traditional Doypack material.

### Embodiment 6

This embodiment aims to evaluate the barrier properties (including water vapor transmission and oxygen transmission tests) of the Doypack body materials prepared in Embodiment 1 to 4 and Comparative Experiments 1 to 2 and the sealing performance of the Doypack.

The water vapor transmission rate (WVT) is tested on the W3/031 Water Vapor Transmission Rate Tester(produced by Labthink Instruments Co., Ltd.) in accordance with GB/T1037-1988. The experimental conditions are: temperature 38±0.6° C., relative humidity 90%±2%, and test area 33 cm².

The Oxygen transmission rate (O₂TR) is tested on sealing tester in accordance with GB/T1038-2000 in a VAC-V2 Gas Permeability Tester(produced by Labthink Instruments Co., Ltd.). The experimental conditions are: temperature 23±2° C., relative humidity 0%.

The sealing performance is tested on is in accordance with GB/T15171-1994, Method 2A. The test results are shown in Table 2.

TABLE 2
Barrier performance and sealing
performance of different Doypacks

| | | | Sealing |
|---|---|---|---|
| | WVT | O₂TR | Performance |
| Film type | (g/m²*24 h) | (cm³/m²*24 h*0.1 MPa) | (50 kPa) |
| Embodiment 1 | 9.2584 | 1.2373 | no-leakage |
| Embodiment 2 | 8.2465 | 0.9526 | no-leakage |
| Embodiment 3 | 5.3132 | 0.6118 | no-leakage |
| Embodiment 4 | 2.6992 | 0.3279 | no-leakage |
| Comparative | 265.6 | 1260.6271 | no-leakage |
| Experiment 1 | | | |
| Comparative | 4.3128 | 29.3564 | no-leakage |
| Experiment 2 | | | |

From the data in Table 2, it can be concluded that the oxygen permeability of the high-barrier biodegradable Doypack made by the present disclosure is significantly lower than that of the traditional Doypack. When the thickness of the first barrier layer reaches 40 microns, the water vapor transmission rate of the high-barrier biodegradable Doypack is also lower than that of the traditional Doypack. In general, the barrier performance of the high-barrier biodegradable Doypack provided by the present disclosure is better than that of the traditional Doypack. In addition, the test results of the sealing performance show that the high barrier biodegradable Doypack has good sealing performance.

The PLGA and PGA used in the present embodiment are produced by our company. Other raw materials such as PBAT, PPC, PBS, Poly (N-Propionyl aziridine), maleic anhydride, o-Phthalic anhydride, Erucylamide, nano-silicon dioxide, White mineral oil, single gloss white kraft paper, Organic modified montmorillonite, hyperbranched polyester HyPer C181, hyperbranched polyester HyPer C100, tributyl O-acetylcitrate, Polyvinyl acetate, antioxidant 168, antioxidant 1010 can be purchased directly from the market.

What is claimed is:

1. A method of preparing a high-barrier biodegradable Doypack includes the following steps:
process 1. prepare high-barrier biodegradable self-sealing strip
(1.1) prepare the raw material(weight fractions): 5-10 parts of poly (lactide-co-glycolide) (PLGA), 60-70 parts of polypropylene carbonate (PPC), and 20-30 parts of Polybutylene succinate (PBS), 1 part of Poly (N-Propionylaziridine), 0.5 parts of o-Phthalic anhydride, 0.2 parts of erucylamide, 0.5 parts of nano-silicon dioxide, 0.3 parts of white mineral oil.
(1.2) mix uniformly the PLGA, PPC, PBS, Poly (N-Propionylaziridine), o-Phthalic anhydride, erucylamide, nano-silicon dioxide, white mineral oil in step (1.1) and add them to the parallel twin screw extruder (commercially equipment, prior art), melt blending and air-cooled pelletizing to prepare high-barrier biodegradable self-sealing strip modified material.
(1.3) the high-barrier biodegradable self-sealing strip modified material prepared in step (1.2) is added to a bone strip extruder (commercially available, prior art), melted, extruded, water-cooled and shaped, and made into a high-barrier Biodegradable self-sealing strips
process 2: prepare five-layer composite high-barrier biodegradable film roll
(2.1) PBAT, organic modified montmorillonite, hyperbranched polyester HyPer C181, and white oil are mixed uniformly and then added to the parallel twin screw extruder, melted, blended and air-cooled pelletizing to prepare the bonding layer modification material.
(2.2) PGA, tributyl O-acetylcitrate, Polyvinyl acetate, and antioxidant 168 are mixed uniformly and then added to the parallel twin screw extruder, melted, blended and air-cooled pelletizing to prepare a first barrier layer modified material.
(2.3) PPC, maleic anhydride, antioxidant 1010, hyperbranched polyester HyPer C100, and white mineral oil are mixed uniformly and then added to the parallel twin screw extruder, melted, blended and air-cooled pelletizing to prepare a second barrier layer modified material.
(2.4) add the modified materials prepared in steps (2.1), (2.2), (2.3) and PBS separately to the four extruders of a four-layer coextrusion casting machine (commercially equipment, prior art); starts the four extruders in sequence; by adjusting the rotating speed of each extruder, four-layer coextruded cast film with different thickness for each layer can be prepared; the four-layer coextruded cast film is composed of a heat sealing layer, a second barrier layer, a first barrier layer and a bonding layer from top to bottom; after the melt flow is stable, it is coated on the single side glossy white kraft paper and the rough surface of the single side glossy white kraft paper is bonding with the bonding layer of the melt; after trimming, it is made into a five-layer composite high-barrier biodegradable film roll; the five-layer composite high-barrier biodegradable film is used to prepare the body of high-barrier biodegradable bag; from the outside to the inside, the five-layer composite high-barrier biodegradable film are: a printing layer, a bonding layer, a first barrier layer, a second barrier layer, and a heat seal layer.
(3) the high-barrier biodegradable self-seal strip prepared in step (1.3) and the five-layer composite high-barrier biodegradable film roll prepared in step (2.4) are prepared into a high-barrier biodegradable Doypack by a bone-sticking three-side sealing bag making machine.

2. The method of claim 1, wherein the PLGA described in step (1.1), the repeating unit —OCH₂CO— accounts for 80%-90%, the weight average molecular weight(MW) of PLGA is 100,000˜200,000.

3. The method of claim 1, wherein the bonding layer modified material described in step (2.1) with the raw material formula(weight fraction): 92 parts of Poly (butyleneadipate-co-terephthalate)(PBAT), 7 parts of organically modified montmorillonite, 1 part of hyperbranched polyester HyPer C181, 0.3 parts of white mineral oil.

4. The method of claim 1, wherein the first barrier modified material prepared in step (2.2) with the raw material formula(weight fraction): 90 parts of polyglycolide (PGA), 5 parts of tributyl O-acetylcitrate, 5 parts of Polyvinyl acetate, and 0.5 parts of antioxidant 168.

5. The method of claim 1, wherein the weight average molecular weight (MW) of PGA described in step (2.2) is 150,000˜300,000, and the residual amount of Glycolide is not more than 0.3 wt %.

6. The method of claim 1, wherein the second barrier layer modified material prepared in step (2.3) with the raw material formula(weight fraction): 100 parts of polypropylene carbonate(PPC), 0.5 parts of maleic anhydride, 0.3 parts of antioxidant 1010, and 0.5 parts of hyperbranched polyester HyPer C100, 0.3 parts of white mineral oil.

7. The method of claim 1, wherein in the coextruded cast film specified in step (2.4), the thickness of the bonding layer is 5-10 microns.

8. The method of claim 1, wherein in the coextruded cast film specified in step (2.4), the thickness of the first barrier layer is 20-40 microns.

9. The method of claim 1, wherein in the coextruded cast film specified in step (2.4), the thickness of the second barrier layer is 20-40 microns.

10. A high-barrier biodegradable Doypack prepared by the method according to claims 1, it is characterized in that it is composed of a high-barrier biodegradable self-seal strip and a five-layer composite high-barrier biodegradable Doypack body.

11. A high-barrier biodegradable Doypack prepared by the method according to claims 2, it is characterized in that it is composed of a high-barrier biodegradable self-seal strip and a five-layer composite high-barrier biodegradable Doypack body.

12. A high-barrier biodegradable Doypack prepared by the method according to claims 3, it is characterized in that it is composed of a high-barrier biodegradable self-seal strip and a five-layer composite high-barrier biodegradable Doypack body.

13. A high-barrier biodegradable Doypack prepared by the method according to claims 4, it is characterized in that it is composed of a high-barrier biodegradable self-seal strip and a five-layer composite high-barrier biodegradable Doypack body.

14. A high-barrier biodegradable Doypack prepared by the method according to claims 5, it is characterized in that it is composed of a high-barrier biodegradable self-seal strip and a five-layer composite high-barrier biodegradable Doypack body.

15. A high-barrier biodegradable Doypack prepared by the method according to claims 6, it is characterized in that it is composed of a high-barrier biodegradable self-seal strip and a five-layer composite high-barrier biodegradable Doypack body.

16. A high-barrier biodegradable Doypack prepared by the method according to claims 7, it is characterized in that it is composed of a high-barrier biodegradable self-seal strip and a five-layer composite high-barrier biodegradable Doypack body.

17. A high-barrier biodegradable Doypack prepared by the method according to claims 8, it is characterized in that it is composed of a high-barrier biodegradable self-seal strip and a five-layer composite high-barrier biodegradable Doypack body.

18. A high-barrier biodegradable Doypack prepared by the method according to claims 9, it is characterized in that it is composed of a high-barrier biodegradable self-seal strip and a five-layer composite high-barrier biodegradable Doypack body.
